(19) United States
(12) Patent Application Publication
(10) Pub. No.: US 2003/0149617 A1
(43) Pub. Date: Aug. 7, 2003

(54) Dynamic fee system for the efficient utilization of a vehicle sharing system

(76) Inventor: Minoru Kobayashi, Tochigi (JP)

Correspondence Address: David J. Meyer, Manatt, Phelps & Phillips, LLP, 11355 W. Olympic Blvd., Los Angeles, CA, 90064, US

(21) Appl. No.: 10/072,418

(22) Filed: Feb. 5, 2002

(51) Int. Cl. G06F 17/60

(52) U.S. Cl. 705/13

(57) ABSTRACT

The invention provides a dynamic fee system usable in a vehicle sharing system. The system adjusts the applicable fees based on vehicle inventory at multi-port parking facilities. The system includes determining when a vehicle inventory at a port facility is optimal at a vehicle departure or destination port. Optimal inventory is when the number of vehicles contained with the port balance user demand and/or vehicle inventory is at neither a deficit nor a surplus at a port facility. Once an optimum inventory is determined, a base fee is established. The fee charged is equal to the base fee, above the base fee, or below the base fee when the vehicles located at the departure port are at optimum inventory, below optimum inventory, or above optimum inventory respectively.

### BACKGROUND OF THE INVENTION

1. Field of the Invention

The present invention relates to vehicle allocation methods usable in a vehicle sharing system.

2. Description of the Related Art

The need to efficiently and economically allocate vehicles has arisen as different models of vehicle sharing develop. The typical rental car experience is well known. Whereby a user enters a vehicle rental facility and contracts to exclusively use an available vehicle for a determined period of time. Additional models of ownership free vehicle use (shared-vehicle systems) have been developed and include vehicle sharing systems and what are described as “station cars.”

The premise of vehicle sharing is simple. Individuals gain the benefits of private car use without the costs and responsibilities of ownership, while society benefits from more efficient vehicle usage. More specifically, vehicle sharing allows a household to access, as needed, a fleet of shared-use vehicles. Vehicle sharing may be thought of as organized short-term car rental. Generally, participants pay a usage fee each time they use a vehicle.

Vehicle sharing might take a variety of forms. It might be neighborhood based, catering to residents who use the vehicles for short round trips to pick up goods and travel to social and recreational activities; it might jointly serve individuals commuting to work or school in peak hours and fleets during work hours; it might serve tourists or second-home residents; or it might be a complex multi-nodal regional system serving millions.

The station car concept is slightly different; however, the distinctions between it and vehicle sharing are becoming blurred as the two methods begin to share the positive aspects of each system, thereby merging into a single shared-vehicle model. For example both shared-vehicle systems require similar reservation and billing systems, fleet management systems, vehicle access systems, insurance, vehicles, and other hardware and software. In addition, the success of both systems relies on their ability to effectively make multiple uses of the vehicles within the fleet at all times. In order to accomplish this end, vehicle distribution must be controlled in order to maintain a supply of vehicles at the various rental facilities. Providing for the multiple use of the vehicles within a fleet ensures that there are an adequate number of vehicles available to meet user demand and creates a more economically viable and efficient use of the system. A more efficient use of shared vehicles provides for the largest societal advantage as well since fewer vehicles are used to handle the same user transportation requirements.

Shared vehicle systems generally rely on multiple ports from which vehicles can be hired and returned to in order to make the system highly flexible. A large number of ports allows a user to hire a vehicle at one port and leave it at a different port near their destination. However, whenever a vehicle is not returned to the location that it was obtained from, the vehicles within the rental establishment become maldistributed, i.e., the supply in some ports will become depleted, while other ports will have a surplus of available vehicles. In order for the various ports to maintain an adequate supply of vehicles to meet user demand, methods of vehicle relocation are employed. Methods of relocation typically include a vendor's employee either driving or towing the vehicles to depleted ports. However, such methods of relocating vehicles are time consuming, heavy-duty tasks that negatively affect the cost of operation of a shared vehicle fleet and the efficiency of the system itself.

Thus, what is needed is a method wherein the users of the system help to maintain an appropriate distribution of vehicles amongst ports.

### SUMMARY OF THE INVENTION

The present invention is directed to methods for the efficient utilization of a vehicle sharing system by satisfying the need to maintain an appropriate distribution of vehicles amongst ports.

To achieve the above objective, the invention makes use of a dynamic fee system that acts to reduce the number of vehicle relocations performed by a fleet operator, improving the overall efficiency and economic viability of a shared vehicle system.

The methods are based on the premise that an efficient vehicle sharing system would create a situation where the users of the system actively participate in maintaining an appropriate distribution of vehicles amongst the available ports. The system employs a novel dynamic fee structure, which influences users to actively participate in the distribution process.

As mentioned in the Background section, multiple-port vehicle sharing is a highly flexible system that allows users to leave their vehicles at a port near their destination. Meanwhile, there can be unbalanced distribution of vehicles at particular ports during certain hours of the day. Some ports will end up having a surplus of vehicles relative to the need, while others will have a deficit. A fleet operator must then either have to deal with a situation where the number of vehicles does not meet user demand or incur the labor and expense of manually relocating vehicles. The goal, therefore, is to maintain the ports at an optimum inventory, whereby the supply of vehicles balances the user demand, through the participation of the system's users. The present invention encourages users to maintain this balanced state by instituting a dynamic fee structure that charges users a relatively larger fee when a vehicle is used in a way that increases an unbalanced distribution state, and less when a vehicle is used to improve vehicle distribution. By actively, if not indirectly, inviting users to participate in the positive distribution of vehicles, the present invention minimizes a fleet operator's relocation tasks.

Another aspect that the invention addresses is fact that the ports of a vehicle sharing system have a specific physical capacity in terms the number of vehicles that can be parked on the premises. An additional need for relocating vehicles arises when there are not enough parking spaces within a given port to handle the number vehicles. To be able to evaluate the situation where the number of vehicles exceeds the number of parking spaces or there is a deficit of vehicles, upper and lower thresholds are set relative to a condition when a optimum inventory would be achieved at a given port. This optimum inventory is achieved when either the user demand balances the vehicle inventory and/or when the parking area is neither at total capacity nor at a deficit. Where a port is nearly full of parked vehicles, an upper threshold is reached. A lower threshold is reached when there is a deficit of vehicles parked at a given port facility. These thresholds above and below the port's optimum inventory are used to determine the turning points of the dynamic fee structure. Thresholds can either be fixed or variable.

Users have access to information, which may be displayed on a screen located at a given port, regarding the fees applicable to hiring a vehicle from a departure point and arriving at a specific destination point. In a particular embodiment of the invention, the optimum inventory of a departure port is ascertained based on user demand and/or port capacity. Once an optimum inventory is determined, a base fee is established. The fee charged is equal to the base fee, above the base fee, or below the base fee when the vehicles located at the departure port are at optimum inventory, below optimum inventory, or above optimum inventory respectively.

In another embodiment of the invention, the optimum inventory of the destination port is considered in the dynamic fee system. The optimum inventory of a destination port is ascertained based on user demand and/or port capacity and a base fee is established. The fee charged is equal to the base fee, above the base fee, or below the base fee when the vehicles located at the destination port are at optimum inventory, above optimum inventory, or below optimum inventory respectively.

In further embodiments of the invention, information regarding the vehicle inventory of the departure and destination port is combined to generate a dynamic fee schedule. For example, the fee previously established by the system given the vehicle inventory at a departure port is equal to the previously determined fee, above the previously determined fee, or below the previously determined fee when the vehicles located at the destination port are at optimum inventory, above optimum inventory, or below optimum inventory respectively.

In yet further embodiments of the invention, the fee established by the system at a destination port is equal to the previously determined fee, above the previously determined fee, or below the previously determined fee when the vehicles located at the departure port are at optimum inventory, below optimum inventory, or above optimum inventory respectively.

These and other features, aspects, and advantages of the present invention will become better understood with reference to the following, figures, description and appended claims.

### BRIEF DESCRIPTION OF THE DRAWINGS

FIG. 1 is a flowchart of a vehicle allocation algorithm utilizing the present invention in a vehicle sharing system;

FIG. 2 is a diagram showing the manner in which the optimal inventory can be determined at a vehicle port facility;

FIG. 3 is a table indicating the dynamic fee effect on a departure port base fee relative to the vehicle inventory at the user's destination port; and

FIG. 4 is a table indicating the dynamic fee effect on a destination port base fee relative to the vehicle inventory at the user's departure port.

### DESCRIPTION

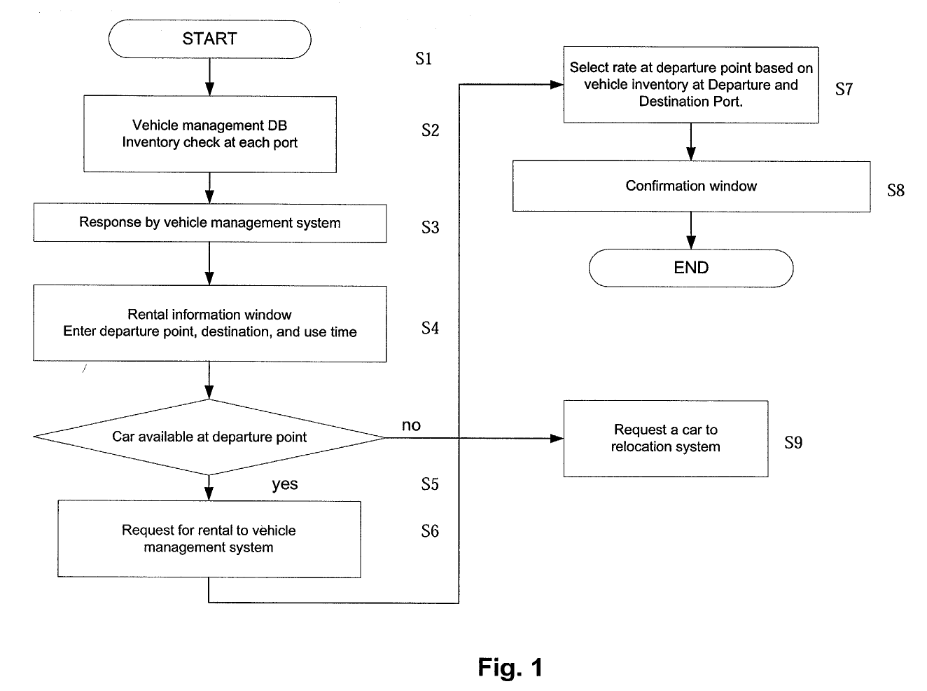

Shown in FIG. 1 is a flowchart of a vehicle sharing system utilizing the present invention to determine the appropriate fee to help maintain or establish the optimal vehicle inventory within the system's port facilities. The vehicle management database is computer based and is utilized by the user to check the vehicle inventory at each port in a step S2. A user gains access and submits information to the vehicle management database system using a touch screen, keyboard, mouse, or similar input device. The vehicle management system then responds in a step S3 to a user request submitted via a vehicle rental information window displayed by the computer monitor which accepts the user's information regarding the user's destination port, departure port, and intended duration of use in a step S4. The vehicle management system determines whether a vehicle is available at the selected departure port in a step S5.

If no vehicle is available at the user's selected departure port, the vehicle management system requests a vehicle to be relocated to the selected departure port and the user is informed of the length of time until the vehicle will be available for use in a step S9. The user may also be informed if there are vehicles available at a nearby departure port.

If a vehicle is available at the user's selected departure port, the request is submitted to the vehicle management system in a step S6 and the fee is determined according to the present invention in a step S7 (see below) and displayed to the user. A confirmation window is then displayed if the user accepts the rental terms in a step S8.

Each port facility utilizes a display device to display the current fees to users. This is accomplished through the use of computer monitors, television monitors, electronic messaging, or other similar devices. The fee can be calculated based on a specific user request with respect to the user's information regarding their desired departure and destination port as described above. The vehicle sharing system can also calculate and display the fees for other departure and destination ports. In addition or as a substitute, the information can be displayed for all users to observe, whereby the fees from various but specific departure ports to various but specific destination ports are displayed and constantly updated according to the dynamic fee system of the present invention.

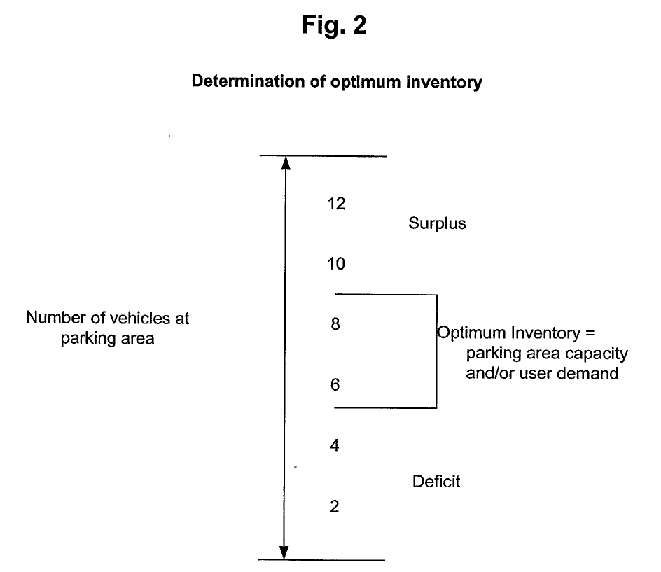

FIG. 2 is a diagram showing how the optimum inventory at a given port can be determined. Determination of the optimum inventory is the first step in the dynamic fee system used in a step S7. The optimum inventory is achieved when either the user demand balances the vehicle inventory and/or when the parking area is neither at total capacity (surplus) nor at a deficit. Where a port is nearly full of parked vehicles, an upper threshold is reached. A lower threshold is reached when there is a deficit of vehicles parked at a given port facility. These thresholds above and below the port's optimum inventory are used to determine the turning points of the dynamic fee structure. Thresholds can either be fixed or variable.

Likewise, with respect to user demand, a deficit is created when more vehicles are requested at a given port than available vehicles. A surplus is created when the vehicle inventory at a given port is not adequately utilized. These thresholds above and below the port's optimum inventory are used to determine the turning points of the dynamic fee structure. Thresholds can either be fixed or variable.

The optimum inventory according to FIG. 2 can be determined using the parking capacity method alone or in combination with the user demand calculations. Alternatively, the optimum inventory can be determined using the user demand method alone or in combination with the parking capacity method.

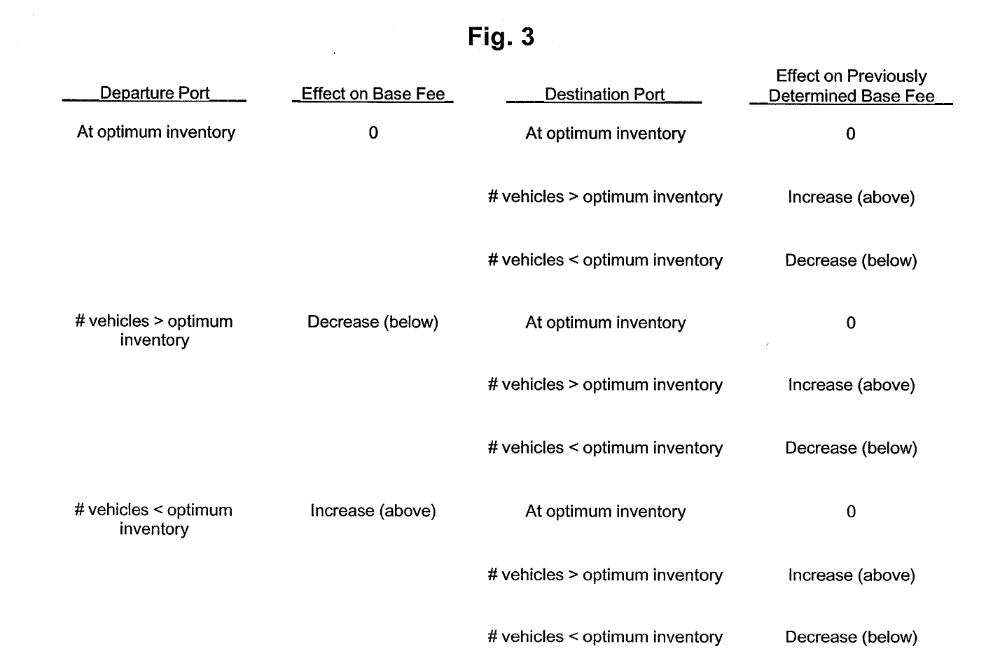

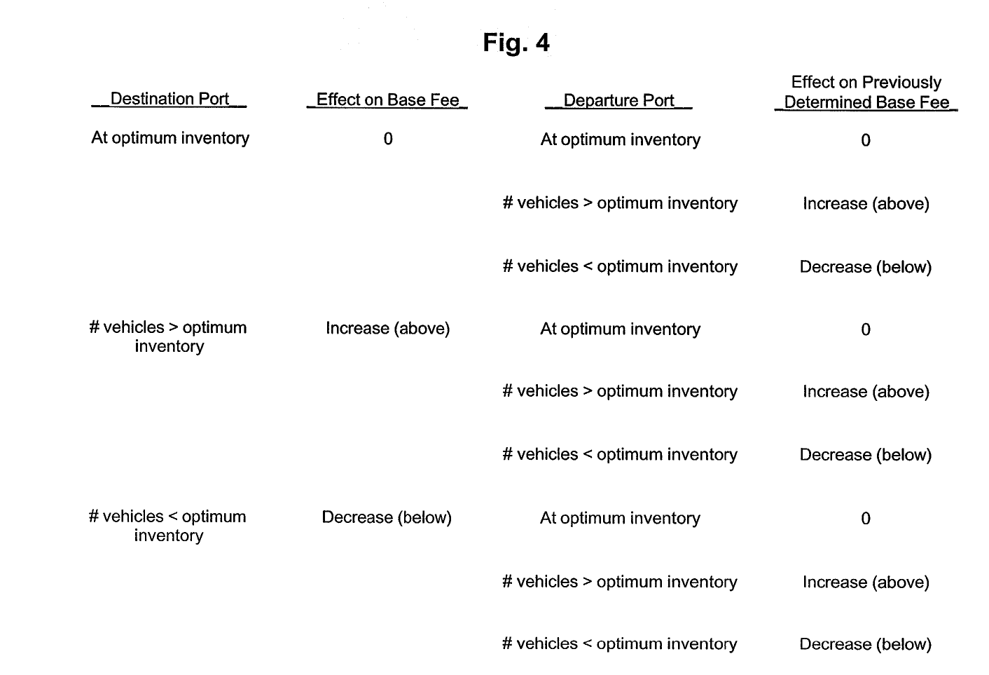

Once the optimum inventory is determined, for example at a departure port, a dynamic fee structure can be established as illustrated in the tables in FIG. 3 and FIG. 4. With respect to the departure port inventory (FIG. 3), the fee charged is equal to the base fee, above the base fee, or below the base fee when the vehicles located at the departure port are at optimum inventory, below optimum inventory, or above optimum inventory respectively (left side of table in FIG. 3).

The optimum inventory of the destination port can also be considered in the dynamic fee system (FIG. 4). After the optimum inventory base fee is established at the destination port, the fee charged is equal to the base fee, above the base fee, or below the base fee when the vehicles located at the destination port are at optimum inventory, above optimum inventory, or below optimum inventory respectively (left side of table in FIG. 4).

Information regarding the vehicle inventory of the departure and destination port is then combined to generate a dynamic fee schedule as shown in the right side of the tables in FIGS. 3 and 4. As shown in FIG. 3, the fee previously established by the system given the vehicle inventory at a departure port is equal to the previously determined fee, above the previously determined fee, or below the previously determined fee when the vehicles located at the destination port are at optimum inventory, above optimum inventory, or below optimum inventory respectively.

As shown in FIG. 4, the fee established by the system at a destination port is equal to the previously determined fee, above the previously determined fee, or below the previously determined fee when the vehicles located at the departure port are at optimum inventory, below optimum inventory, or above optimum inventory respectively.

Although a certain embodiment of the present invention has been shown and described in detail, it should be understood that various changes and modifications may be made therein without departing from the scope of the appended claims.

What is claimed is:

1. A dynamic fee system usable in a method for the efficient utilization of a vehicle sharing system wherein a user of the system hires a vehicle for use at a departure port and returns the vehicle at a destination port, and wherein each port has a means to display current fees to users, the method comprising the steps of:
a) Determining the optimum vehicle inventory at each departure port;
b) Determining a base fee for the use of a vehicle when the departure port is at optimum inventory; and
c) Displaying a fee below the base fee when the number of vehicles at the departure port is above the optimum inventory.

2. A dynamic fee system usable in a method for the efficient utilization of a vehicle sharing system wherein a user of the system hires a vehicle for use at a departure port and returns the vehicle at a destination port, and wherein each port has a means to display current fees to users, the method comprising the steps of:
a) Determining the optimum vehicle inventory at each departure port;
b) Determining a base fee for the use of a vehicle when the departure port is at optimum inventory; and
c) Displaying a fee above the base fee when the number of vehicles at a departure port is below the optimum inventory.

3. A dynamic fee system usable in a method for the efficient utilization of a vehicle sharing system wherein a user of the system hires a vehicle for use at a departure port and returns the vehicle at a destination port, and wherein each port has a means to display current fees to users, the method comprising the steps of:
a) Determining the optimum vehicle inventory at each destination port;
b) Determining a base fee for the use of a vehicle when the destination port is at optimum inventory; and
c) Displaying a fee above the base fee when the number of vehicles at a destination port is above the optimum inventory.

4. A dynamic fee system usable in a method for the efficient utilization of a vehicle sharing system wherein a user of the system hires a vehicle for use at a departure port and returns the vehicle at a destination port, and wherein each port has a means to display current fees to users, the method comprising the steps of:
a) Determining the optimum vehicle inventory at each destination port;
b) Determining a base fee for the use of a vehicle when the destination port is at optimum inventory; and
c) Displaying a fee below the base fee when the number of vehicles at a destination port is below the optimum inventory.

5. A dynamic fee system usable in a method for the efficient utilization of a vehicle sharing system wherein a user of the system hires a vehicle for use at a departure port and returns the vehicle at a destination port, and wherein each port has a means to display current fees to users, the method comprising the steps of:
a) Determining the optimum vehicle inventory at each departure port;
b) Determining a base fee for the use of a vehicle when the departure port is at optimum inventory; and
c) Displaying the base fee when the number of vehicles at the departure port is at optimum inventory.

6. A dynamic fee system usable in a method for the efficient utilization of a vehicle sharing system wherein a user of the system hires a vehicle for use at a departure port and returns the vehicle at a destination port, and wherein each port has a means to display current fees to users, the method comprising the steps of:
a) Determining the optimum vehicle inventory at each destination port;
b) Determining a base fee for the use of a vehicle when the destination port is at optimum inventory; and
c) Displaying the base fee when the number of vehicles at a destination port is at optimum inventory.

7. The dynamic fee system usable in a method for the efficient utilization of a vehicle sharing system according to claim 1 wherein the method of determining the fee further comprises:
a) Determining the optimum vehicle inventory at each destination port;
b) Determining the fee for the use of a vehicle in claim 1; and
c) Displaying a fee above the fee derived in step b) when the number of vehicles at a destination port is above the optimum inventory.

8. The dynamic fee system usable in a method for the efficient utilization of a vehicle sharing system according to claim 1 wherein the method of determining the fee further comprises:
a) Determining the optimum vehicle inventory at each destination port;
b) Determining the fee for the use of a vehicle in claim 1; and
c) Displaying a fee below the fee derived in step b) when the number of vehicles at a destination port is below the optimum inventory.

9. The dynamic fee system usable in a method for the efficient utilization of a vehicle sharing system according to claim 1 wherein the method of determining the fee further comprises:
a) Determining the optimum vehicle inventory at each destination port;
b) Determining the fee for the use of a vehicle in claim 1; and
c) Displaying the fee derived in step b) when the number of vehicles at a destination port is at optimum inventory.

10. The dynamic fee system usable in a method for the efficient utilization of a vehicle sharing system according to claim 2 wherein the method of determining the fee further comprises:
a) Determining the optimum vehicle inventory at each destination port;
b) Determining the fee for the use of a vehicle in claim 2; and
c) Displaying a fee above the fee derived in step b) when the number of vehicles at a destination port is above the optimum inventory.

11. The dynamic fee system usable in a method for the efficient utilization of a vehicle sharing system according to claim 2 wherein the method of determining the fee further comprises:
a) Determining the optimum vehicle inventory at each destination port;
b) Determining the fee for the use of a vehicle in claim 2; and
c) Displaying a fee below the fee derived in step b) when the number of vehicles at a destination port is below the optimum inventory.

12. The dynamic fee system usable in a method for the efficient utilization of a vehicle sharing system according to claim 2 wherein the method of determining the fee further comprises:
a) Determining the optimum vehicle inventory at each destination port;
b) Determining the fee for the use of a vehicle in claim 2; and
c) Displaying the fee derived in step b) when the number of vehicles at a destination port is at optimum inventory.

13. The dynamic fee system usable in a method for the efficient utilization of a vehicle sharing system according to claim 3 wherein the method of determining the fee further comprises:
a) Determining the optimum vehicle inventory at each departure port;
b) Determining the fee for the use of a vehicle in claim 3; and
c) Displaying a fee below the fee derived in step b) when the number of vehicles at a departure port is above the optimum inventory.

14. The dynamic fee system usable in a method for the efficient utilization of a vehicle sharing system according to claim 3 wherein the method of determining the fee further comprises:
a) Determining the optimum vehicle inventory at each departure port;
b) Determining the fee for the use of a vehicle in claim 3; and
c) Displaying a fee above the fee derived in step b) when the number of vehicles at a departure port is below the optimum inventory.

15. The dynamic fee system usable in a method for the efficient utilization of a vehicle sharing system according to claim 3 wherein the method of determining the fee further comprises:
a) Determining the optimum vehicle inventory at each departure port;
b) Determining the fee for the use of a vehicle in claim 3; and
c) Displaying the fee derived in step b) when the number of vehicles at a departure port is at optimum inventory.

16. The dynamic fee system usable in a method for the efficient utilization of a vehicle sharing system according to claim 4 wherein the method of determining the fee further comprises:
a) Determining the optimum vehicle inventory at each departure port;
b) Determining the fee for the use of a vehicle in claim 4; and
c) Displaying a fee below the fee derived in step b) when the number of vehicles at a departure port is above the optimum inventory.

17. The dynamic fee system usable in a method for the efficient utilization of a vehicle sharing system according to claim 4 wherein the method of determining the fee further comprises:
a) Determining the optimum vehicle inventory at each departure port;
b) Determining the fee for the use of a vehicle in claim 4; and
c) Displaying a fee above the fee derived in step b) when the number of vehicles at a departure port is below the optimum inventory.

18. The dynamic fee system usable in a method for the efficient utilization of a vehicle sharing system according to claim 4 wherein the method of determining the fee further comprises:
a) Determining the optimum vehicle inventory at each departure port;
b) Determining the fee for the use of a vehicle in claim 4; and
c) Displaying the fee derived in step b) when the number of vehicles at a departure port is at optimum inventory.

19. The dynamic fee system usable in a method for the efficient utilization of a vehicle sharing system according to claim 5 wherein the method of determining the fee further comprises:
a) Determining the optimum vehicle inventory at each destination port;
b) Determining the fee for the use of a vehicle in claim 5; and
c) Displaying a fee above the fee derived in step b) when the number of vehicles at a destination port is above the optimum inventory.

20. The dynamic fee system usable in a method for the efficient utilization of a vehicle sharing system according to claim 5 wherein the method of determining the fee further comprises:
a) Determining the optimum vehicle inventory at each destination port;
b) Determining the fee for the use of a vehicle in claim 5; and
c) Displaying a fee below the fee derived in step b) when the number of vehicles at a destination port is below the optimum inventory.

21. The dynamic fee system usable in a method for the efficient utilization of a vehicle sharing system according to claim 5 wherein the method of determining the fee further comprises:
a) Determining the optimum vehicle inventory at each destination port;
b) Determining the fee for the use of a vehicle in claim 5; and
c) Displaying the fee derived in step b) when the number of vehicles at a destination port is at optimum inventory.

22. The dynamic fee system usable in a method for the efficient utilization of a vehicle sharing system according to claim 6 wherein the method of determining the fee further comprises:
a) Determining the optimum vehicle inventory at each departure port;
b) Determining the fee for the use of a vehicle in claim 6; and
c) Displaying a fee below the fee derived in step b) when the number of vehicles at a departure port is above the optimum inventory.

23. The dynamic fee system usable in a method for the efficient utilization of a vehicle sharing system according to claim 6 wherein the method of determining the fee further comprises:
a) Determining the optimum vehicle inventory at each departure port;
b) Determining the fee for the use of a vehicle in claim 6; and
c) Displaying a fee above the fee derived in step b) when the number of vehicles at a departure port is below the optimum inventory.

24. The dynamic fee system usable in a method for the efficient utilization of a vehicle sharing system according to claim 6 wherein the method of determining the fee further comprises:
a) Determining the optimum vehicle inventory at each departure port;
b) Determining the fee for the use of a vehicle in claim 6; and
c) Displaying the fee derived in step b) when the number of vehicles at a departure port is at optimum inventory.
